(19) United States
(12) Patent Application Publication
(10) Pub. No.: US 2020/0387901 A1
(43) Pub. Date: Dec. 10, 2020

(54) SYSTEMS AND METHODS FOR FACILITATING NETWORK REQUESTS

(71) Applicant: MASTERCARD INTERNATIONAL INCORPORATED, Purchase, NY (US)

(72) Inventors: Paul Kellett, London (GB); Edward William Judge, Fleet (GB)

(21) Appl. No.: 16/881,970

(22) Filed: May 22, 2020

Related U.S. Application Data
(60) Provisional application No. 62/858,017, filed on Jun. 6, 2019.

(51) Int. Cl. G06Q 20/40; G06Q 20/22; G06Q 20/26

(52) U.S. Cl. CPC G06Q 20/405; G06Q 20/26; G06Q 20/4014; G06Q 20/227

(57) ABSTRACT

Systems and methods are provided for facilitating network requests regarding transit. One exemplary method includes receiving, at a computing device, from a network, a request directed to a user account having a first resource and a second resource, where the request includes a category code for an entity and an identifier for the user account, and determining, by the computing device, whether the category code is indicative of a first segment of entities or a second segment of entities. The method then also includes, when the category code is indicative of the first segment, assigning the request to the first resource and responding to the request based on the first resource and, when the category code is indicative of the second segment, assigning the request to the second resource and responding to the request based on the second resource.

### CROSS-REFERENCE TO RELATED APPLICATION

This application claims the benefit of, and priority to, U.S. Provisional Application No. 62/858,017 filed on Jun. 6, 2019. The entire disclosure of the above-referenced application is incorporated herein by reference.

### FIELD

The present disclosure generally relates to systems and method for use in facilitating network requests and, in particular, to systems and methods for facilitating such network requests with regard to transit.

### BACKGROUND

This section provides background information related to the present disclosure which is not necessarily prior art.

Different transit options are often offered in a variety of city, suburban, or rural settings, including subways, busses, taxi cabs, ferries, etc. For use of the transit, individuals typically purchase paper tickets, or passes, for the transit. More recently, the paper tickets or passes have been supplanted with mobile versions thereof, whereby unified gateways are provided through which transit may be purchased. For example, a monthly subscription service may provide an individual with access to one or more public transit services, where the individual is able to use the service for a specific duration, a specific numbers of “rides,” or a specific distance, and where the cost of the monthly subscription provides for the rides or the distance. In order to provide this access for multiple different types of transit, a host of the subscription service is required to interact and contract with each of the different desired transit services to be used by the individual, whereby the transit services will then permit the individual to ride and the host will arrange for payment to the different transit services. With that said, as the geographic region of transit services grows, the host of the subscription service engages additional transit services to permit individuals to use transit through the entire geographic region.

### DRAWINGS

The drawings described herein are for illustrative purposes only of selected embodiments and not all possible implementations, and are not intended to limit the scope of the present disclosure.

FIG. 1 illustrates an exemplary system of the present disclosure suitable for use in facilitating network transactions between consumers and transit service providers, through a common account, whereby transit services are then provided to the consumers by different ones of the transit service providers;

FIG. 2 is a block diagram of a computing device that may be used in the exemplary system of FIG. 1; and

FIG. 3 is an exemplary method for facilitating network transactions between a consumer and one or more of multiple different transit service providers, through use of a common account, whereby the consumer is then able to use transit provided by the one or more of the multiple different transit service providers, and which may be implemented in the system of FIG. 1.

Corresponding reference numerals indicate corresponding parts throughout the several views of the drawings.

### DETAILED DESCRIPTION

The description and specific examples included herein are intended for purposes of illustration only and are not intended to limit the scope of the present disclosure.

Consumers pay for transit services in a variety of different manners. In connection therewith, when “mobility as a service,” or MaaS, arrangements are provided by service hosts to the consumers in connection with such transit services, the hosts are required to individually interact with each of multiple different transit service providers to determine applicable terms and/or conditions of the providers regarding the transit services. As such, depending on a configuration of a given geographic region and the available transit services therein, the hosts may be challenged to contract with a large number of transit service providers to make the MaaS arrangements appealing to the consumers, and/or may be limited to the specific regions in which the hosts are present and/or the consumers reside. What's more, transit accounts provided by the service hosts and associated with the consumers may be limited to only funding interactions with transit service providers.

Uniquely, the systems and methods herein provide for use of a dual balance common account by a consumer, as implemented by a service host, to pay for transit offered by different transit service providers (or transit service merchants) and also to purchase desired products through other non-transit merchants. In so doing, the consumer is able to direct a subscription payment to the service host for the transit (and for use of the unique dual balance account), even in the absence of contract(s) between the service host and the transit service providers. In particular, the service host is configured to issue a payment account for the consumer, which is specific to the consumer. The payment account (also referred to as a consumption account) is funded with a transit balance, by the service host, at one or more intervals based on a subscription type of the consumer, and is also funded with a general balance by the consumer. Then, when the consumer attempts to transact with a merchant (be it a transit service provider or a non-transit merchant), a payment card (associated with the consumption account) or a mobile application at a communication device associated with the consumer is able to provide a credential for the consumption account to the merchant. In turn, the merchant initiates a transaction for the interaction, whereby payment is received by the merchant for the requested product via the consumption account. The transit balance of the account will be used to fund the transaction when the merchant is indicated as being a transit service provider in the transaction (e.g., based on a particular merchant category code (MCC), etc.), and the general balance will be used to fund the transaction when the merchant is not indicated as being a transit service provider (i.e., for all other transactions). In this manner, the service host leverages an unconventional payment account setup (having the dual balance) to fund not only the consumer's transit transactions but also general transactions, whereby the consumption account is controlled by the service host yet utilized by the consumer in a conventional manner. The consumer is thus able to participate in the transit services provided by the host through the dual balance consumption account, by paying the subscription fees (e.g., monthly, or through other payment intervals and/or types of payments, etc.), and while still leaving the details of the transit interactions to the service host, but with the service host not obligated to make special arrangements with each of multiple different transit service providers as is typically required. What's more, the consumer is also able to utilize the consumption account to fund the general balance for use in transactions apart from transit service providers.

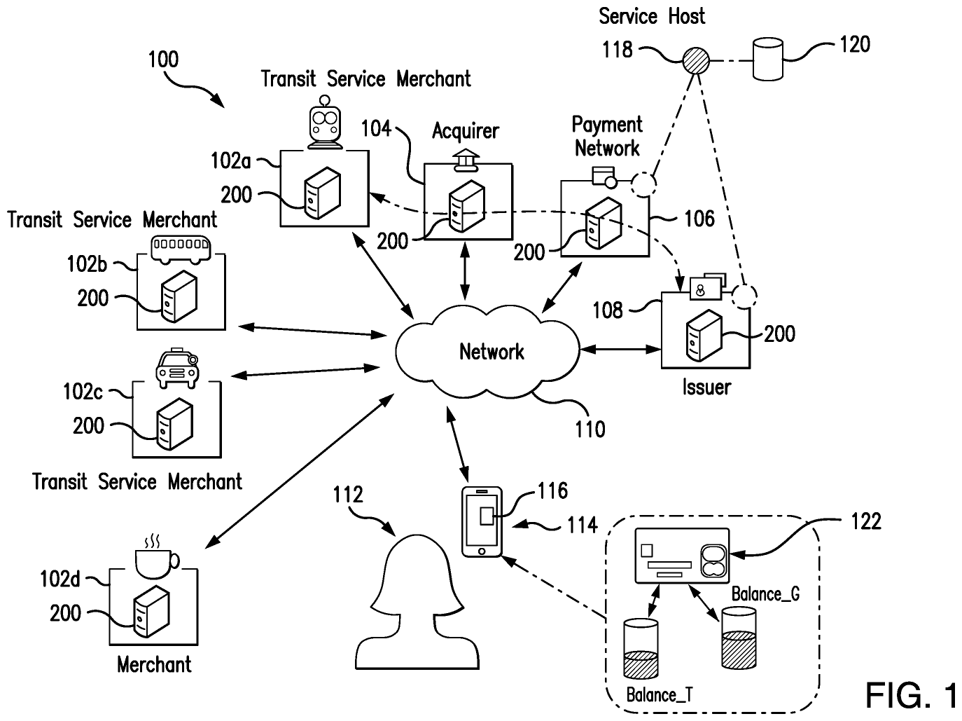

FIG. 1 illustrates an exemplary system 100, in which one or more aspects of the present disclosure may be implemented. Although the system 100 is presented in one arrangement, other embodiments may include systems arranged otherwise depending, for example, on travel options available to consumers, transit options available to the consumers, accessibility of transit data, accessibility of user/consumer data, processing of purchase options for travel and non-travel services and/or products, etc.

The system 100 generally relates to travel and includes three transit service merchants 102a-c, a merchant 102d that in general is not related to transit services, an acquirer 104 associated with accounts for each of the transit service merchants 102a-c and the merchant 102d, a payment network 106, and an issuer 108, each of which is coupled to network 110. The network 110 may include, without limitation, a local area network (LAN), a wide area network (WAN) (e.g., the Internet, etc.), a mobile network, a virtual network, and/or another suitable public and/or private network capable of supporting communication among two or more of the parts illustrated in FIG. 1, or any combination thereof. For example, network 110 may include multiple different networks, such as a private payment transaction network made accessible by the payment network 106 to the acquirer 104 and the issuer 108 and, separately, the public Internet, which is accessible as desired to the merchants 102a-c, the acquirer 104, the payment network 106, the issuer 108, and a consumer 112 (and more specifically, a communication device 114 associated with the consumer 112).

Each of the transit service merchants 102a-c (broadly, part of a first segment of merchants relating to travel/transport services and/or products) is generally associated with travel services, and transport of persons from one location to another. In this exemplary embodiment, the transit service merchant 102a is associated with rail travel (e.g., travel by train, subway, tram, streetcar, trolley, metro, etc.) in one or more regions. The transit service merchant 102b is associated with bus travel. And, the transit service merchant 102c is associated with private travel (e.g., travel by taxi, ride service (e.g., Uber™ service, Lyft™ service, etc.), etc.). In general, the transit service merchants 102a-c offer transit to users in exchange for a fee, charge, and/or fare. For example, the transit service merchant 102a conventionally offers for sale and sells train passes, to users, per ride, for multiple rides, per duration (e.g., weekly passes, monthly passes, etc.), and/or for unlimited rides, etc. The train passes permit the purchasing users to travel in train(s) associated with the transit service merchant 102a, as the train(s) travel from station to station. Similarly, for example, the transit service merchants 102b and 102c conventionally offer fairs, passes, fees per ride, etc., whereby the users pay and the transit service merchants 102b-c provide travel to the users from one location to another. Conversely, the merchant 102d (broadly, part of a second segment of merchants not relating to travel/transport services and/or products) offers products and/or services for sale to consumers, which are not transit services, whereby the merchant 102d is generally defined as not a transit service provider. The merchant 102d may include, without limitation, a restaurant, a department store, a grocery store, a coffee shop, a telecommunication provider, a plumber, or any other suitable merchant, etc.

In this exemplary embodiment, the merchants 102a-d are associated with categories specific to the products and/or services offered for sale thereby. In particular, the merchants 102a-c are associated with transit MCCs, such as for example, 4111 (Commuter Transport, Ferries), 4112 (Passenger Railways), 4121 (Taxicabs/Limousines), 4131 (bus lines), 4784 (Tolls/Bridge Fees), and/or 4789 (Transportation Services (not elsewhere classified)), etc. And, the merchant 102d is not associated with any of these transit MCCs, but is instead associated with a MCC indicative of the products and services offered thereby. In this particular embodiment, the merchant 102d may be a coffee shop and may be associated with the MCC 5812 (Eating Places and Restaurants).

It should be appreciated that while only three transit service merchants 102a-c and one non-transit merchant 102d are shown in FIG. 1, a different number of transit service merchants and/or different types of transit service merchants and/or other non-transit merchants may be included in other system embodiments. For example, other types of transit service merchants may include boat or ferry operators, airplane pilots/services, helicopter pilots/services, charter services, etc.

The system 100 includes the consumer 112 (broadly, a user) as a potential user of the transit offered by the different transit service merchants 102a-c and a potential customer of the merchant 102d. The consumer 112 is associated with the communication device 114. In this exemplary embodiment, the communication device 114 includes a portable communication device, such as, for example, a smartphone, a tablet, or a wearable device (e.g., an Apple Watch® wearable device, etc.), etc. In connection therewith, the communication device 114 includes a network-based application, which is referred to herein as a transit application (or transit app) 116 (e.g., as a MaaS application or an issuer-provided application, etc.). And, the transit app 116 is provided to configure the communication device 114 to operate as described herein. That said, the transit app 116 may be a standalone application within the communication device 114, or it may be incorporated into another network-based application such as, for example, a virtual wallet at the communication device 114 (e.g., via a software-development kit (SDK), etc.), etc.

It should be appreciated that the acquirer 104 (associated with the merchants 102a-d) and the issuer 108 in the system 100 generally include one or more banking institutions, etc., which are configured to interaction with the payment network 106 to facilitate account transactions between accounts issued by the acquirer 104 and the issuer 108. That said, while only one acquirer 104, one payment network 106, one issuer 108, one consumer 112, and one communication device 114 are illustrated in FIG. 1, it should be appreciated that a different number of these entities and devices (and their associated components) may be included in the system 100, or may be included as a part of systems in other embodiments, consistent with the present disclosure.

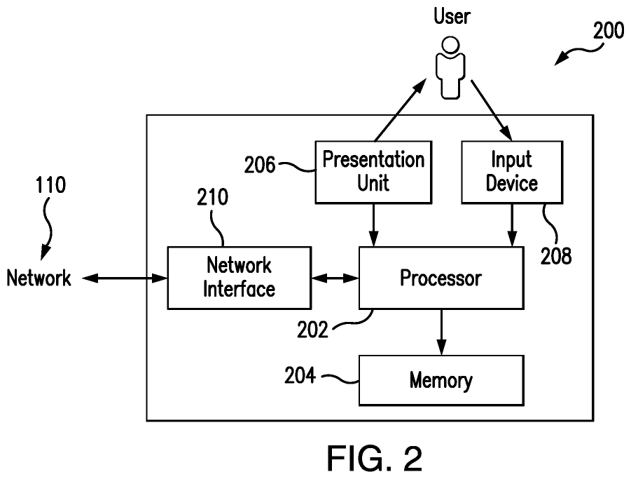

FIG. 2 illustrates an exemplary computing device 200 that can be used in the system 100. The computing device 200 may include, for example, one or more servers, workstations, personal computers, laptops, tablets, smartphones, PDAs, etc. In addition, the computing device 200 may include a single computing device, or it may include multiple computing devices located in close proximity or distributed over a geographic region, so long as the computing devices are specifically configured to function as described herein. In the exemplary embodiment of FIG. 1, each of the transit service merchants 102a-c, the merchant 102d, the acquirer 104, the payment network 106, and the issuer 108 are illustrated as including, or being implemented in, computing device 200, coupled to the network 110. For example, the computing devices 200 of the transit merchants 102a-c and the merchant 102d may include, without limitation, one or more point-of-sale (POS) devices configured to initiate payment account transactions based on, for example, account credentials, etc. provided in exchange for transit services rendered, where the POS devices are then consistent with computing device 200. In addition, the communication device 114 associated with the consumer 112 may be considered a computing device consistent with computing device 200. With that said, the system 100 should not be considered to be limited to the computing device 200, as described below, as different computing devices and/or arrangements of computing devices may be used. In addition, different components and/or arrangements of components may be used in other computing devices.

Referring to FIG. 2, the exemplary computing device 200 includes a processor 202 and a memory 204 coupled to the processor 202. The processor 202 may include one or more processing units (e.g., in a multi-core configuration, etc.). For example, the processor 202 may include, without limitation, one or more processing units (e.g., in a multi-core configuration, etc.), including a central processing unit (CPU), a microcontroller, a reduced instruction set computer (RISC) processor, an application specific integrated circuit (ASIC), a programmable logic device (PLD), a gate array, and/or any other circuit or processor capable of the functions described herein.

The memory 204, as described herein, is one or more devices that permit data, instructions, etc., to be stored therein and retrieved therefrom. The memory 204 may include one or more computer-readable storage media, such as, without limitation, dynamic random access memory (DRAM), static random access memory (SRAM), read only memory (ROM), erasable programmable read only memory (EPROM), solid state devices, flash drives, CD-ROMs, thumb drives, floppy disks, tapes, hard disks, and/or any other type of volatile or nonvolatile physical or tangible computer-readable media. The memory 204 may be configured to store, without limitation, consumption account balances, transaction data, transit data, subscription types and/or statuses, account credentials, and/or other types of data suitable for use as described herein. Furthermore, in various embodiments, computer-executable instructions may be stored in the memory 204 for execution by the processor 202 to cause the processor 202 to perform one or more of the functions described herein (e.g., in the method 300, etc.), such that the memory 204 is a physical, tangible, and non-transitory computer readable storage media. Such instructions often improve the efficiencies and/or performance of the processor 202 that is operating as described herein whereby upon such performance of the one or more functions, the computing device may be considered a unique, special purpose device. It should be appreciated that the memory 204 may include a variety of different memories, each implemented in one or more of the functions or processes described herein.

In the exemplary embodiment, the computing device 200 includes a presentation unit 206 that is coupled to the processor 202 (however, it should be appreciated that the computing device 200 could include output devices other than the presentation unit 206, etc.). The presentation unit 206 outputs information (e.g., subscription statuses, subscription options, transit options and/or histories, etc.), either visually or audibly to a user of the computing device 200, for example, the consumer 112, etc. It should be further appreciated that various interfaces (as described herein) may be displayed at computing device 200, and in particular at presentation unit 206, to display such information. The presentation unit 206 may include, without limitation, a liquid crystal display (LCD), a light-emitting diode (LED) display, an organic LED (OLED) display, an “electronic ink” display, speakers, etc. In some embodiments, presentation unit 206 may include multiple devices.

The computing device 200 also includes an input device 208 that receives inputs from the user (i.e., user inputs) such as, for example, selections of transit, selections of associated users, instructions to pay at the transit service merchants 102a-c, etc. The input device 208 is coupled to the processor 202 and may include, for example, a keyboard, a pointing device, a touch sensitive panel (e.g., a touch pad or a touch screen, etc.), another computing device, and/or an audio input device. Further, in various exemplary embodiments, a touch screen, such as that included in a tablet, a smartphone, or similar device, may behave as both the presentation unit 206 and the input device 208.

In addition, the illustrated computing device 200 also includes a network interface 210 coupled to the processor 202 and the memory 204. The network interface 210 may include, without limitation, a wired network adapter, a wireless network adapter, a mobile network adapter (e.g., an NFC adapter, a Bluetooth adapter, etc.), or other device capable of communicating to one or more different networks, including the network 110. Further, in some exemplary embodiments, the computing device 200 may include the processor 202 and one or more network interfaces incorporated into or with the processor 202.

Referring again to FIG. 1, the system 100 includes a service host 118, which is configured, by executable instructions, generally, to interact with the transit app 116 (e.g., at the communication device 114, etc.) and to otherwise operate as described herein (e.g., to facilitate the dual balance account described herein, etc.). The service host 118 is shown in FIG. 1 as a standalone part of the system 100, and is generally consistent with computing device 200. Alternatively, and as indicated by the dotted lines in FIG. 1, the service host 118 may be incorporated, in whole or in part, into the payment network 106 and/or issuer 108. In addition, the service host 118 is coupled to a transit data structure 120, which may be standalone from the service host 118 or, as indicated by the dotted line, may be incorporated in whole, or in part, with the service host 118. The data structure 120 includes consumer profiles, subscription plans, etc. as will be described herein, for access by the service host 118.

In this exemplary embodiment, the service host 118 is associated with an account for use as described herein (and referred to herein as a common account). The common account may be issued by the issuer 108, or by another banking institution, or otherwise, and is associated with and/or incorporated with the service host 118 (although this is not required in all embodiments). Similarly, the consumer 112 is associated with an account (referred to herein as a funding account), from which funds may be deducted and/or transferred consistent with the description herein. The funding account, like the common account, may be issued by the issuer 108 or another banking institution, or otherwise (e.g., and may include a payment account (via a card on file, etc.), a banking account, etc.).

When the consumer 112 determines to subscribe with the service host 118 for provision of transit (as described herein), the consumer 112 accesses the transit app 116 at the communication device 114 (or, as needed, initially installs the transit app 116 and then accesses it). In response, the communication device 114, as configured by the transit app 116, interacts with the service host 118 (e.g., via network 110, etc.). In particular, for example, the communication device 114, as configured by the transit app 116, may retrieve one or more subscription plans from the service host 118 (as stored in the data structure 120) or receive the one or more subscription plans from the service host 118, and display one or more interfaces to the consumer 112, which lists and/or explains the one of more subscription plans. In connection therewith, and as generally described herein, the consumer 112 has a commercial relationship with the service host 118 (or the entity operating the service host 118), for example, via the transit app 116, etc.

Without limitation, exemplary subscription plans that may be displayed to the consumer 112 at the communication device 114 are illustrated in Table 1. While the illustrated subscription plans each relate to plans having predefined travel packages, it should be appreciated that other plans may instead include pay-as-you-go plans or pay-after-you-go-plans. For example, in such other plans, the consumer 112 may subscribe to the plan (potentially for a cost, or not) and then pay a scheduled rate for travel used (e.g., a discounted rate based on the consumer's subscription, etc.). In addition, the pay-after-you-go-plans may include the ability for service host 118, for example, to retrospectively charge the consumer 112 for a journey that changed from the original plan, or that needed a top up to cover an additional stop beyond what the subscription or original payment allowed for.

TABLE 1

| Subscription | | |
|---|---|---|
| Plan | Plan Inclusions | Cost |
| #1 | 15 bus rides | $15/week |
| | 10 train rides | |
| #2 | 8 bus rides | $45/month |
| | 12 train rides | |
| | 15.0 miles taxi | |
| #3 | 24 bus rides | $60/week |
| | 6.0 miles taxi | |
| | 1 day light van use | |
| #4 | 10 train rides | $30/week |
| | 5 days bike-share scheme use | |
| | 10.0 miles taxi | |
| #5 | Unlimited bus | $100/week |
| | Unlimited train | |
| | 2 days sports car use | |

As shown in Table 1, the subscription plan #1, for example, includes a mix of bus rides and train rides and a cost per week for such rides, while subscription plan #2 includes a mix of bus, train and taxi rides, and a cost per month therefor. In addition, the subscription plan #3 includes bus rides and taxi rides as well as a light van use. And, subscription plans #4 and #5 similarly include different mixes of transit at a weekly rate. As can be appreciated, the service host 118 may offer such different subscription plans (and others) to consumers (including the consumer 112), each with different mixes of transit, in attempt to accommodate and/or appeal to the different needs and/or desires of the consumers (e.g., city commuters may desire train rides and bike share transit; tradesmen may desire bus rides and occasional van use transit; affluent consumers may desire taxis, trains, and occasional sports car use; etc.). With that said, it should thus be appreciated that the particular subscription plans identified for the consumer 112 in Table 1 may be different in other embodiments, and may have different inclusions by different transit service providers (merchants) in other embodiments. For example, the plans may include different intervals, such as, for example, two weeks, monthly, bi-monthly, quarterly, semi-annually, annually, etc. In addition, the plans may further include different combinations of rides/services at different transit service merchants. For example, one subscription may be limited to train-type transit service merchants (like, the merchant 102a), while other plans may include different types of transit services (such as subscription plans #1 and #2 in Table 1). In general, the consumer 112 is able to select, via the transit app 116 and/or the services host 118, a plan to which to subscribe which best fits the needs of the consumer 112. In addition, in some embodiments, the service host 118 may further allow consumers to customize subscription plans and then provide different rates therefor.

What's more, while each of the subscription plans described herein is stored in the data structure 120 (following generation by the service host 118 or other entity), all or less than all of the subscription plans may be provided by the service host 118 to the communication device 114. For example, the service host 118 may be configured to provide only certain subscription plans to the transit app 116, based on one or more parameters associated with the consumer 112 and/or of the transit desired by the consumer 112, etc. (e.g., based on location(s) associated with the consumer 112, expressed interest(s) by the consumer 112, based on a profile generated by the consumer 112 (e.g., at the transit app 116, etc.), based on transit preferences or the consumer 112, etc.). Conversely, the communication device 114, as configured by the transit app 116, may retrieve only certain subscription plans from the service host 118, again, based on one or more parameters as described above. In still other embodiments, the communication device 114 may be configured to retrieve and/or the service host 118 may be configured to provide all available subscription plans, whereby the consumer 112 may view the plans and select one or more desired plans.

Thereafter in the system 100, the consumer 112 may select one of the subscription plans in order to subscribe thereto. Prior to, or after such selection, the communication device 114, as configured by the transit app 116, may solicit certain consumer information from the consumer 112, such as, without limitation, name, address, phone number, and details of the consumer's funding account (e.g., primary account number (PAN), expiration date, card verification code (CVC), etc.), etc. Upon receipt of the consumer information, the communication device 114, as configured by the transit app 116, transmits a subscription request to the service host 118, which includes, in this embodiment, the received consumer information and the consumer's selection of one or more of the given subscription plans.

The service host 118, in turn, is configured to compile and store a consumer profile for the consumer 112 in the data structure 120 (e.g., based on the consumer information solicited by the communication device 114 and/or transit app 116, based on profile information already present in the transit app 116, etc.). Further, the service host 118 is configured to transmit a request to the issuer 108, to issue a consumption account (broadly, a user account) for the consumer 112 (which generally has a payment account number, etc.). In response, the issuer 108 is configured to issue the consumption account and to identify the consumption account to the service host 118 (whereby the consumption account is generally maintained by the issuer 108 for the consumer 112, but without the consumer 112 having separate access and/or control thereto). The consumption account is generally specific to the consumer 112, and thus, not generally usable by other consumers.

The consumption account issued to the consumer 112 is represented in FIG. 1 by payment card 122 (e.g., such that the physical payment card 122 may be provided to the consumer 112 to allow for use of the consumption account, etc.) (e.g., where the payment card 122 is EMV enabled, etc.). However, it should be appreciated that the consumption account is not limited to an account associated with such a payment card (e.g., it may be associated with a virtual wallet account as described more below, etc.). As illustrated in FIG. 1, the consumption account is associated with two difference balances (or resources) (i.e., the consumption account is a dual balance account), with one balance being a transit balance (i.e., balance_t in FIG. 1) and the other balance being a non-transit or general balance (i.e., balance_g in FIG. 1), as will be described in more detail below. In connection therewith, while the two balances are both associated with the consumption account (and are both associated with the same payment account number of the consumption account (e.g., in the illustrated embodiment the two different balances do not have different account numbers (although this is not required in all embodiments), etc.), the issuer 108 is configured to maintain separate accountings for the two balances for the different uses thereof described below.

In connection with providing the consumption account to the consumer 112, the service host 118 is configured to add one or more identifiers, credentials, etc. of the consumption account (e.g., a PAN, etc.) to the consumer profile for the consumer 112 in the data structure 120. In addition, in this embodiment, the issuer 108 is also configured to provision a credential for the consumption account to the transit app 116 in the communication device 114 (whereby the transit app 116 may also operate as a payment application with regard to the consumption account (although this is not required in all embodiments, for example, those where the payment card 122 is provided to the consumer 112 whereby the consumer 112 is able to use the payment card 122 to fund purchases using the consumption account independent of the communication device 114, etc.), etc.). In connection therewith, the transit app 116 is configured to securely store the payment credential for the consumption account associated with the consumer 112 by the service host 118. For example, the issuer 108 may provision the credential for the consumer's consumption account to the transit app 116 over network 110 (e.g., via a connection maintained by the communication device 114 through the network 110, etc.). The credential may include a token representative of the consumer's consumption account, where the token may be created and provisioned by a service such as the Mastercard Digital Enablement Service (MDES). Upon receipt of the credential, the transit app 116 may then store the credential securely within the app 116 and enable its use to make payments via the communication device 114 (e.g., via NFC or Bluetooth payment capabilities of the communications device 114, etc.), which are funded via the consumption account.

In the consumer profile for the consumer 112 generated by the service host 118 and stored at the data structure 120, or more generally in the data structure 120 in association with the consumer 112, the service host 118 is configured to compile rules for the consumer 112 for use of the transit balance of the consumption account (generally independent of any input from the consumer 112, i.e., the consumer 112 does not contribute to and/or choose the rules and/or the content of the rules relating to the transit balance (e.g., the service host 118 generates and/or identifies the rules free of any input from the consumer 112, etc.)). The rules may include, for example, a subscription fee date for the selected subscription plan, upon which a recurring payment is initiated from the consumer's funding account to the service host's common account whereby the consumer 112 pays for the selected subscription plan (e.g., a recurring payment of $45 per month, on the 10th of the month, for selection of subscription plan #2 in Table 1; etc.). In addition, the rules may include replenishment instructions for the transit balance of the consumption account, which may indicate intervals of fund transfers and/or thresholds for such transfers of funds (from the common account of the service host 118 to the consumer's transit balance in the consumption account). For example, the rules may require a transfer of $12.50 every Monday at 10:00 am, or more generally a transfer of $17.50 when the transit balance in the consumption account falls below a $15.00 threshold. Or, as another example, the rules may require the consumption account have a minimum transit balance that is enough to cover up to a day's worth of rides (e.g., $50, etc.), and to replenish the transit balance of the consumption account (e.g., overnight, etc.) when needed.

Then, upon initiation of the consumer's subscription with the service host 118 and consistent with the rules, the service host 118 is configured to direct at least an initial transfer of funds, from the common account, for example, to the transit balance of the consumer's consumption account (in a generally conventional manner). Thereafter, the service host 118 is configured to direct one or more additional transfers of funds, from the common account, for example, to the transit balance of the consumption account, as indicated by the subscription plan and/or rules included in the consumer profile for the consumer 112 (again in a generally conventional manner).

Also upon initiation of the consumer's subscription with the service host 118, the service host 118 is configured to confirm the selected subscription plan(s) with the consumer 112, for example, at the transit app 116 (or, potentially, at a website associated with the service host 118, etc.). And, the communication device 114, as configured by the transit app 116, is configured to receive such a confirmation, and to interact with the consumer 112 and the service host 118 to provide the subscription plan details to the consumer 112, as well as transaction histories, etc.

In addition, the consumer 112 may opt to enable the consumption account for other, non-transit transactions, which include, in general, transactions at merchant other than transit merchants (e.g., at the merchant 102d, etc.) or for purchases of products and/or services other than transit services (or products). In connection therewith, the consumption account includes the general balance, as shown in FIG. 1, which is separate from the transit balance. To fund the general balance, the consumer 112 may transfer funds, via the transit app 116 (or, again, via a website associated with the service host 118, etc.), from his/her funding account to the general balance of the consumption account. Specifically, in this embodiment, the consumer 112 accesses the transit app 116 at the communication device 114 (or, as needed, initially installs the transit app 116 and then accesses it). In response, the communication device 114, as configured by the transit app 116, interacts with the consumer 112 to solicit transfer details (e.g., account details for his/her funding account (either by manual entry to the transit app 116 by the consumer 112 or by selection of existing accounts stored to or provisioned to the transit app 116, etc.), etc.) and with the service host 118 (e.g., via network 110, etc.) to effect the transfer. In particular, when an option is selected by the consumer 112 to transfer funds which includes details of the transfer, the communication device 114, as configured by the transit app 116, transmits a fund transfer request to the service host 118, which includes, in this embodiment, an identification of the funding account, an identification of the general balance of the consumption account, and an amount to be transferred, as provided by the consumer 112, to the general balance of the consumption account.

The service host 118, in turn, is configured to transmit a request to the issuer 108 (as associated with the consumption account), to transfer the identified funds from the consumer's funding account (e.g., as identified from the transit app 116, etc.) to the general balance of the consumption account. In response, the issuer 108 is configured to transfer the funds, as directed (e.g., via an appropriate transaction to the consumer's funding account (and directed to the issuer of the funding account), etc.), and to return a confirmation of the general balance of the consumption account to the service host 118, which may then be provided to the consumer 112 at the transit app 116 (e.g., whereby the issuer 108, then, is configured to manage the consumption account and the corresponding general balance associated therewith, etc.). It should be appreciated that the same issuer need not be associated with the consumer's funding account and the consumption account. For example, in embodiments where the issuer of the consumer's account is different from the issuer 108 of the consumption account, the issuer 108 of the consumption account may facilitate the transfer of funds to the consumption account (upon receipt of the request from the service host 118) in a conventional manner (e.g., via the payment network 106, otherwise, etc.).

It should be appreciated that in one or more embodiments, the fund transfer to the general balance of the consumption account may omit the service host 118, whereby the consumer 112 may, for example, interact directly with the issuer 108 of the consumption account, or directly with the issuer of his/her account (when different from the issuer 108). For example, in such embodiments, the transit app 116 may transmit the fund transfer request directly to the issuer 108 (e.g., where the transit app 116 is provided by the issuer 108, which also provides the consumption account; etc.) and the issuer 108 then facilitates the fund transfer (generally as described above).

In addition in this exemplary embodiment, the consumer profile for the consumer 112 may further include rules associated with the general balance of the consumption account (e.g., transaction limits limiting amounts of some or all transactions directed to the general balance, minimum balance rules for the general balance, limits on types of merchants to which transactions may be made to the general balance, etc.). In connection therewith, the consumer 112 may interact with the service host 118 to establish such rules (e.g., the consumer 112 may edit or update his/her consumer profile, via the transit app 116, to include such rules; etc.). In this manner, certain aspects of the consumer profile for the consumer 112 may be accessible to and/or editable by the consumer 112 (e.g., rules relating to the general balance, transit preferences, etc.), while other aspects of the consumer profile may not (e.g., rules relating to the transit balance, etc.).

Later in the system 100, when the consumer 112 desires to use transit from the transit service merchant 102a (or from another one of the transit merchants 102b-c or to purchase a product or service from the merchant 102d), and attempts such transit (or purchase), the consumer 112 accesses the transit app 116 (in order to provide details of the consumption account). In turn, the communication device 114, as configured by the transit app 116, cooperates with and/or communicates with the computing device 200 at the given transit service merchant 102a (e.g., a POS terminal at the merchant 102a, etc.), for example, to facilitate the transit. Or, the consumer 112 presents the payment card 122 to the transit service merchant 102a, whereby the transit service merchant 102a receives corresponding details of the consumption account for the payment card 122. Specifically, for example, the communication device 114, as configured by the transit app 116, or the payment card 122 passes the payment credential associated with the consumer's consumption account, as provisioned thereto by the issuer 108, to the transit service merchant 102a. And, the transit service merchant 102a is configured to initiate a payment account transaction for the desired transit, by compiling and transmitting an authorization request to the issuer 108, via the acquirer 104 and the payment network 106, as is conventional (and as indicated by the dotted line in FIG. 1).

In connection therewith, the authorization request includes an MCC for the merchant 102a. The issuer 108 is then configured to identify the transaction as associated with a dual balance consumption account (e.g., based on a PAN for the account or other identifier included in the authorization request, etc.) and to identify the MCC in the authorization request as directed to a transit merchant. The issuer 108 is further configured to then direct the transaction to the transit balance based on the MCC (and, for all subsequent transactions identified by the MCC). Based on the transit balance for the consumption account, the issuer 108 is configured to approve, or decline, the transaction and to generate and transmit an authorization reply to the transit service merchant 102a. If approved, the consumer 112 is permitted entry and to proceed with the desired transit from the merchant 102a. If not (e.g., if the transit balance has insufficient funds, etc.), the consumer 112 is not permitted entry and/or the transit is not provided to the consumer 112. The same generally applies to the other transit merchants 102b-c.

Alternatively, when the transaction by the consumer 112 is at the non-transit merchant 102d, the authorization request includes a different MCC for the merchant 102d. The issuer 108 is then again configured to identify the transaction as associated with a dual balance consumption account (e.g., based on a PAN for the account or other identifier included in the authorization request, etc.) and to identify the MCC in the authorization request as directed to a non-transit merchant. The issuer 108 is further configured to then direct the transaction to the general balance based on the MCC. Based on the general balance for the consumption account, the issuer 108 is configured to approve, or decline, the transaction and to generate and transmit an authorization reply to the transit service merchant 102d. If approved, the consumer 112 is permitted to collect the purchased product from the merchant 102d. If not (e.g., if the general balance has insufficient funds, etc.), the consumer 112 is not permitted to collect the product or an alternative form of payment is requested.

Apart from the above, the transit service merchant 102a may be an out-of-scheme merchant such that the service host 118 does not have a direct contract with the transit service merchant 102a. However, as described, the consumer 112 is still able to use funds from the transit balance of the consumption account to pay for transit provided by the transit service merchant 102a. The communication device 114, via the transit app 116, simply functions as a payment device/application (or, through use of the actual payment card 122), drawing down some of the funds already held by the service host 118 in the transit balance of the consumption account for the consumer 112. Alternatively, for interactions by the consumer 112 at transit service merchants that are in-scheme merchants (where the service host 118 has a direct contract for providing transit to consumers associated with the service host), the service host 118 may pay the in-scheme merchants for transit rendered in a conventional B2B (business-to-business) fashion (e.g., from the service host's common account, etc.) under the terms of the direct contracts that they have with the service host 118 (e.g., in the form of a monthly or biannual settlement of charges, etc.). Thus, as can be appreciated herein, the service host 118 facilities transit, through use of the transit balance of the consumption account, not only with in-scheme transit service merchants but also with out-of-scheme transit service merchants. Similar transactions may be funded through the general balance of the consumption account of in-scheme or preferred non-transit merchant and out-of-scheme or other non-transit merchants.

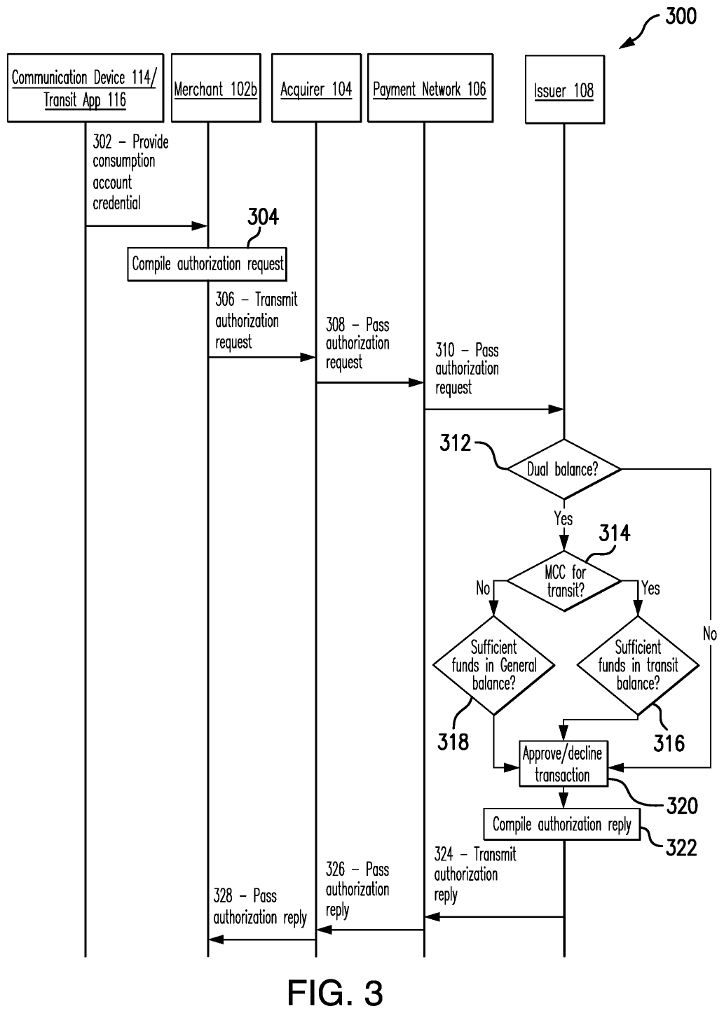

FIG. 3 illustrates an exemplary method 300 for facilitating a network request with regard to purchase of transit. The exemplary method 300 is described with reference to FIG. 1 as implemented in the transit app 116 and the service host 118, and also with reference to the computing device 200. However, it should be understood that the methods herein are not limited to the exemplary system 100 or the exemplary computing device 200. Likewise, the systems and the computing devices herein should not be understood to be limited to the exemplary method 300.

At the outset in the method 300, in this exemplary embodiment, the consumer 112 is generally registered to the service host 118 and has the transit app 116 installed to his/her communication device 114. In addition, the transit app 116 is associated with a consumption account as issued by the issuer 108, and includes a transit balance (linked to the general account of the service host 118) and a general balance (linked to the funding account of the consumer 112). Further, the consumer 112 has purchased a transit subscription from the service host 118 for travel involving the transit service merchants 102a-c.

In connection therewith, the consumer 112 may interact with one or more of the transit service merchants 102a-c when desired to travel from one location to another, or may interact with the merchant 102d when desired to purchase a non-transit product or service. Upon entry and/or approaching a bus, a taxi cab, etc. associated with one of the transit service merchants 102a-c, for example, the transit service merchant 102b, the consumer 112 selects to pay for transit services associated therewith via the transit app 116 (or, alternatively, via a virtual wallet including the transit app 116, or via use of the payment card 122, etc.). The consumer 112 may do so by launching the transit app 116 at the communication device 114, by selecting to pay for the transit service within the transit app 116, by tapping a POS device associated with the merchant 102b, for example, or otherwise (e.g., installed in a platform gate-line array or at a boarding door on a bus, etc.). When the POS device is used to facilitate the transaction, the transit app 116 (or associated virtual wallet or the associated payment card 122) provides, at 302, the consumption account credential (provisioned thereto) to the POS device of the merchant 102b. It should be appreciated that the transmission of the consumption account credential occurs regardless of the type of merchant (e.g., transit or non-transit merchant, etc.).

The merchant 102b then compiles, at 304, an authorization request for the transaction (e.g., where, through use of the POS device, transaction is processed as a contactless EMV transaction; etc.). The authorization request includes the consumption account credential received from the consumer 112 (e.g., the PAN for the consumption account, etc.) and details for the merchant 102b, including, for example, an MCC for the merchant 102b, etc. The merchant 102b then transmits the authorization request to the acquirer 104 associated with the merchant 102b, at 306. The acquirer 104, in turn, passes the authorization request, at 308, to the payment network 106. And, the payment network 106 passes the authorization request, at 310, to the issuer 108 (as associated with the consumption account).

Upon receipt thereof, the issuer 108 initially determines, at 312, whether the transaction involves a dual balance consumption account. This may include recognizing the PAN included in the authorization request as relating to such an account (e.g., as falling with a range of PANs designated as consumption accounts, as including one or more digits specific to consumption accounts, etc.).

In turn, when the issuer 108 determines that the transaction is directed to a dual balance consumption account, the issuer 108 then determines, at 314, whether the transaction is directed to a transit merchant or other merchant, in this example, based on the MCC included in the authorization request. In this exemplary embodiment, the issuer 108 includes a data structure of MCCs, which are specific to transit merchants. As such, to determine whether the merchant 102b is a transit merchant or not, the issuer 108 searches in the data structure for the MCC included in the authorization request. When it is found, the issuer 108 determines the MCC is associated with a transit merchant, and when not found, the issuer 108 determines that the MCC is associated with a non-transit merchant. In other embodiments, the issuer may use a merchant ID for the merchant 102b (as included in the authorization request) to determine that the merchant 102b is a transit merchant. For instance, the data structure may include multiple merchant IDs for transit merchants (in general, or specifically associated with the service host 118). And, to determine whether the merchant 102b is a transit merchant or not, the issuer 108 searches in the data structure for the merchant ID of the merchant 102b. When it is found, the issuer 108 determines the merchant 102b is a transit merchant, and when not found, the issuer 108 determines that the merchant 102b is a non-transit merchant.

In the method 300, when the MCC is associated with a transit merchant, as here because the merchant 102b is a transit merchant, the issuer 108 assigns the transaction to the transit balance of the consumption account and determines, at 316, whether there are sufficient funds in the transit balance to pay for the transaction (in a generally conventional manner to determining whether a balance is sufficient for a traditional payment account, etc.). In general, though, based on the rules implemented by the server host 118 and/or issuer 108 regarding the transit balance (as described above), the transit balance should always have sufficient funds for the transaction (as long as the consumer's subscription is active and up to date, etc.). However, in such instances where the transit balance may be insufficient, the service host 118 may have a rule in place that causes funds to be transferred to the consumption account of the consumer 112, for the transit balance, to cover any deficiency in the balance. In any case, in this example, the merchant 102b includes an MCC of 4131 (because merchant 102b is a bus line). As such, at 314, the issuer 108 will determine that the merchant 102b is a transit merchant. And, in some embodiments, in connection therewith the issuer 108 may further use the merchant ID of the merchant 102b to determine the particular amount to be debited from the transit balance for the transit selected by the consumer 112 (based on the particular merchant 102b associated with the merchant ID).

Conversely, when the MCC is associated with a non-transit merchant (such as for a transaction by the consumer 112 using the consumption account at the merchant 102d), the issuer 108 assigns the transaction to the general balance and determines, at 318, whether there are sufficient funds in the general balance of the consumption account. For example, where the merchant 102d initiated the transaction (i.e., initiated the authorization request for the transaction) and has an MCC of 5812, the issuer 108, at 314, will determine that the MCC 5812 included in the authorization request is associated with “Eating Places and Restaurants” and that the merchant 102d is thus a non-transit merchant. As such, the issuer 108 will rely on the general balance of the consumption account for funding a transaction amount identified in the authorization request for the merchant 102d. Here, if the general balance is not sufficient for the given transaction, the consumer 112 may be given an option to fund the transaction with his/her funding account, or the transaction may simply be declined.

With continued reference to FIG. 3, regardless of the whether the transaction is directed to the transit balance or the general balance, the issuer 108 then evaluates the transaction against the respective balance (as discussed above) and determines whether to approve or decline the transaction, at 320, based at least in part on whether the transit balance (or the general balance, as applicable) is sufficient to fund the transaction. It should be appreciated that other criteria, such as for example fraud scoring, etc., may further be employed to determine whether to approve or decline the transaction. A similar analysis is performed when the issuer 108 determines, at 312, that the transaction is not directed to a consumption account (i.e., the issuer 108 then determines whether the balance for the identified account is sufficient to fund the transaction, etc. and then determines, at 320, whether to approve or decline the transaction).

Next in the method 300, at 322, the issuer 108 compiles an authorization reply, indicating the transaction is approved or declined, and transmits, at 324, the authorization reply to the payment network 106. The payment network 106, in turn, passes the authorization reply to the acquirer 104, at 326, which passes the authorization reply, at 328, to the merchant 102b. Thereafter, the merchant 102b either permits the consumer 112 to enter the transit service (or otherwise provides the transit service or ends the transit service), or not, based on the authorization reply (i.e., approve or declined).

Later the transaction is cleared and settled by and between the acquirer 104 (associated with the merchant 102b) and the issuer 108 (from the transit balance or the general balance of the consumption account, as appropriate), via the payment network 106.

In view of the above, the systems and methods herein provide a dual balance consumption account for consumers for use in purchasing transit and other products. One balance associated with the account is loaded by a transit host to provide transit subscription type services for the consumer, and the other balance is loaded by the consumer for general use. In this manner, the dual balance account is provided as a universal use payment account, which is not limited to just transit merchants or otherwise restricted based on merchant types. In general, the dual balance consumption account permits MCC restrictions for one balance, while lifting the MCC restrictions for the other balance. This provides enhanced flexibility and acceptance of the consumption account over prior payment account technologies. What's more, the transit balance aspect of the dual balance consumption account allows for a payment card having credentials for the consumption account (e.g., payment card 122, etc.) or a virtual wallet application having credentials for the consumption account to essentially become a transit-based ticket that can be purchased and provisioned by others to a consumer. In addition, in various embodiments herein, the dual balance consumption account may be coordinated at the payment network and/or the issuer via the service host, whereby a transaction at the merchant is unchanged over conventional transactions (e.g., the authorization request is consistent with those generated for conventional transactions, etc.). In other words, a single payment credential may be submitted to the merchant for the transaction, regardless of which balance of the dual balance consumption account the transaction is directed (in that the MCC directs the payment network and/or the issuer to the appropriate balance, independent of the payment credential provided).

As such, in one exemplary embodiment of the present disclosure, a computer-implemented method for use in facilitating network requests is provided. In this embodiment, the method initially includes issuing an account having a first balance and a second balance. The method then includes receiving, at a computing device, from a payment network, an authorization request for a transaction directed to the issued account where the authorization request includes a merchant category code (MCC) for a merchant (to which the transaction is directed) and an account number indicative of the issued account, and determining, by the computing device, whether the MCC is indicative of a first segment of merchants or a second segment of merchants. In turn, when the MCC is indicative of the first segment of merchants, the method includes assigning the transaction to the first balance and responding to the authorization request based on the first balance (but not based on (or independent of) the payment account number, i.e., such that the first balance is selected based on the MCC even though the payment account number is the same number for use of either the first balance or the second balance). And, when the MCC is indicative of the second segment of merchants, the method includes assigning the transaction to the second balance and responding to the authorization request based on the second balance (but, again, not based on the payment account number, i.e., such that the second balance is selected based on the MCC even though the payment account number is the same number for use of either the first balance or the second balance).

Again and as previously described, it should be appreciated that the functions described herein, in some embodiments, may be described in computer executable instructions stored on a computer readable media, and executable by one or more processors. The computer readable media is a non-transitory computer readable storage medium. By way of example, and not limitation, such computer-readable media can include RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Combinations of the above should also be included within the scope of computer-readable media.

It should also be appreciated that one or more aspects of the present disclosure transform a general-purpose computing device into a special-purpose computing device when configured to perform the functions, methods, and/or processes described herein.

As will be appreciated based on the foregoing specification, the above-described embodiments of the disclosure may be implemented using computer programming or engineering techniques including computer software, firmware, hardware or any combination or subset thereof, wherein the technical effect may be achieved by performing at least one of the following operations: (a) issuing a user account having a first resource (e.g., a first balance, etc.) and a second resource balance (e.g., a second balance, etc.); (b) receiving, at a computing device, from a network (e.g., a payment network, etc.), a request (e.g., an authorization request for a transaction, etc.) directed to the issued account, the request including a category code (e.g., merchant category code (MCC), etc.) for an entity (e.g., a merchant, etc.) and an identifier (e.g., an account number, etc.) for the issued user account; (c) determining, by the computing device, whether the category code is indicative of a first segment of entities or a second segment of entities; (d) when the category code is indicative of the first segment, assigning the request to the first resource in the user account and responding to the request based on the first resource; (e) when the category code is indicative of the second segment, assigning the request to the second resource in the user account and responding to the request based on the second resource; (f) approving a transaction when the category code is indicative of the first segment and the first resource exceeds an amount of the transaction; and (g) compiling an authorization reply, indicating the approval, and transmitting the authorization reply to the network.

Exemplary embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

The terminology used herein is for the purpose of describing particular exemplary embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

When an element or layer is referred to as being “on,” “engaged to,” “connected to,” “coupled to,” “associated with,” included with,” or “in communication with” another element or layer, it may be directly on, engaged, connected or coupled to, associated with, or in communication with the other element or layer, or intervening elements or layers may be present. As used herein, the term “and/or” and the phrase “at least one of” includes any and all combinations of one or more of the associated listed items.

Although the terms first, second, third, etc. may be used herein to describe various features, these features should not be limited by these terms. These terms may be only used to distinguish one feature from another. Terms such as “first,” “second,” and other numerical terms when used herein do not imply a sequence or order unless clearly indicated by the context. Thus, a first feature discussed herein could be termed a second feature without departing from the teachings of the example embodiments.

None of the elements/features recited in the claims are intended to be a means-plus-function element within the meaning of 35 U.S.C. § 112(f) unless an element is expressly recited using the phrase “means for,” or in the case of a method claim using the phrases “operation for” or “step for.”

The foregoing description of exemplary embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. A computer-implemented method for use in facilitating network requests with regard to resources included in a user account, the method comprising:
issuing a user account having a first resource and a second resource, wherein the first resource is maintained separate from the second resource within the user account;
receiving, at a computing device, from a network, a request directed to the issued user account, the request including a category code for an entity and an identifier for the issued user account;
determining, by the computing device, whether the category code is indicative of a first segment of entities or a second segment of entities;
when the category code is indicative of the first segment, assigning the request to the first resource in the user account and responding to the request based on the first resource; and
when the category code is indicative of the second segment, assigning the request to the second resource in the user account and responding to the request based on the second resource.

2. The computer-implemented method of claim 1, wherein the category code includes a merchant category code (MCC); and
wherein determining whether the category code is indicative of a first segment of entities or a second segment of entities includes searching for the MCC in a data structure of MCCs specific to the first segment.

3. The computer-implemented method of claim 1, wherein the request includes an authorization request for a transaction directed to the issued user account, and wherein the first resource includes a first balance in the user account; and
wherein the method further comprises:
approving the transaction when the category code is indicative of the first segment and the first balance exceeds an amount of the transaction; and
compiling an authorization reply, indicating the approval, and transmitting the authorization reply to the network.

4. The computer-implement method of claim 1, wherein the first segment of entities includes transit merchants; and
wherein the second segment of entities includes merchants other than the transit merchants.

5. The computer-implement method of claim 1, wherein the request includes an authorization request for a transaction directed to the issued user account, and wherein the first resource includes a first balance in the user account and the second resource includes a second balance in the user account; and
wherein the method further comprises:
debiting an amount of the transaction from the first balance when the request is assigned to the first balance and is approved; and
debiting the amount of the transaction from the second balance when the request is assigned to the second balance and is approved.

6. The computer-implemented method of claim 5, wherein the first balance includes a transit balance and the second balance includes a general balance.

7. A system for use in facilitating network requests, the system comprising at least one computing device associated with an issuer of accounts, the at least one computing device configured to:
issue an account having a first balance and a second balance, the account having an account number associated with both the first balance and the second balance;
receive, from a payment network, an authorization request for a transaction directed to the issued account, the authorization request including a merchant category code (MCC) and the account number indicative of the issued account;
determine whether the MCC is indicative of a first segment of merchants or a second segment of merchants;
when the MCC is indicative of the first segment of merchants, assign the transaction to the first balance and respond to the authorization request based on the first balance; and
when the MCC is indicative of the second segment of merchants, assign the transaction to the second balance and respond to the authorization request based on the second balance.

8. The system of claim 7, wherein the at least one computing device is configured, in connection with determining whether the MCC is indicative of a first segment of merchants, to search for the MCC in a data structure of MCCs specific to the first segment.

9. The system of claim 7, wherein the at least one computing device is further configured to:
approve the transaction when the MCC is indicative of the first segment and the first balance exceeds an amount of the transaction; and
compile an authorization reply, indicating the approval, and transmit the authorization reply to the payment network.

10. The system of claim 7, wherein the first segment of merchants includes transit merchants; and
wherein the second segment of merchant includes merchants other than the transit merchants.

11. The system of claim 7, wherein the at least one processor is further configured to:
debit an amount of the transaction from the first balance when the transaction is assigned to the first balance and is approved; and
debit the amount of the transaction from the second balance when the transaction is assigned to the second balance and is approved.

12. The system of claim 11, wherein the first balance includes a transit balance and the second balance includes a general balance.

13. A non-transitory computer-readable storage medium including executable instructions for facilitating network requests, which when executed by at least one processor, cause the at least one processor to:
receive, from a payment network, an authorization request for a transaction directed to an account having a first balance and a second balance, wherein the account has an account number associated with both the first balance and the second balance, and wherein the authorization request includes a merchant category code (MCC) and the account number for the account;
determine that the MCC is indicative of either a first segment of merchants or a second segment of merchants;
when the MCC is indicative of the first segment of merchants, assign the transaction to the first balance and respond to the authorization request based on the first balance; and
when the MCC is indicative of the second segment of merchants, assign the transaction to the second balance and respond to the authorization request based on the second balance.

14. The non-transitory computer-readable storage medium of claim 13, wherein the executable instructions, when executed by the at least one processor, further cause the at least one processor to:
approve the transaction when the MCC is indicative of the first segment and the first balance exceeds an amount of the transaction; and
compile an authorization reply, indicating the approval, and transmit the authorization reply to the payment network.

15. The non-transitory computer-readable storage medium of claim 13, wherein the executable instructions, when executed by the at least one processor, further cause the at least one processor to:
debit an amount of the transaction from the first balance when the transaction is assigned to the first balance and is approved; and
debit the amount of the transaction from the second balance when the transaction is assigned to the second balance and is approved.

16. The non-transitory computer-readable storage medium of claim 15, wherein the first balance includes a transit balance and the second balance includes a general balance.

17. The non-transitory computer-readable storage medium of claim 16, wherein the first segment of merchants includes transit merchants; and
wherein the second segment of merchant includes merchants other than the transit merchants.

18. The non-transitory computer-readable storage medium of claim 17, wherein the executable instructions, when executed by the at least one processor in connection with determining that the MCC is indicative of the first segment of merchants or the second segment of merchants, cause the at least one processor to search for the MCC in a data structure of MCCs specific to the first segment.
